(19) United States
(12) Patent Application Publication
(10) Pub. No.: US 2018/0031166 A1
(43) Pub. Date: Feb. 1, 2018

(54) PIPE REPAIR APPARATUS AND METHOD

(71) Applicants: Jeffrey M. URBANSKI, Grand Blanc, MI (US); SOURCE 1 ENVIROMENTAL, LLC, Davison, MI (US)

(72) Inventor: Jeffrey M. Urbanski, Grand Blanc, MI (US)

(73) Assignee: SOURCE 1 ENVIROMENTAL, LLC, Davison, MI (US)

(21) Appl. No.: 15/553,035

(22) PCT Filed: Feb. 23, 2016
(86) PCT No.: PCT/US16/19047

§ 371 Date: Aug. 23, 2017

Related U.S. Application Data
(60) Provisional application No. 62/119,490, filed on Feb. 23, 2015.

(51) Int. Cl. F16L 55/165; F16L 55/30; F16L 55/179; F16L 55/26

(52) U.S. Cl. CPC F16L 55/1654; F16L 55/265; F16L 55/30; F16L 55/179; F16L 55/1656; F16L 2101/18

(57) ABSTRACT

A pipe repair apparatus and method of repairing a main pipe and a lateral pipe is provided. The apparatus includes a packer assembly having a main bladder body with a cylindrical shape extending radially from and along the first axis for inflating in the main pipe. The packer assembly also has a lateral bladder body with a cylindrical shape extending radially from and along a second axis transverse to the first axis for inflating in the lateral pipe. A main liner is disposed about the main bladder body for adhering to the inner surface of the main pipe to repair the main pipe in response to the main bladder body being inflated. Similarly, a lateral liner is disposed about the lateral bladder body for adhering to the inside surface of the lateral pipe to repair the lateral pipe in response to the lateral bladder body being inflated.

### CROSS REFERENCE TO RELATED APPLICATION

This PCT Patent Application claims the benefit of and priority to U.S. Provisional Patent Application Ser. No. 62/119,490 filed Feb. 23, 2015, the entire disclosure of the application being considered part of the disclosure of this application, and hereby incorporated by reference.

### BACKGROUND OF THE INVENTION

### 1. Field of the Invention

The subject invention relates generally to an apparatus for use in repairing main line and lateral line pipes. The subject invention is also related to a method of repairing a main pipe and a lateral pipe extending from the main pipe.

### 2. Description of the Prior Art

Pipes including at least one main pipe and a lateral pipe extending transversely or laterally from the main pipe are commonly used in both fluid supply and return pipe systems and may also be used for sewer pipes, for example. In a collection sewer pipe system, for example, junctions at which lateral pipes intersect with main pipes are generally known to be one of the weakest points. Consequently, leaks can develop at this junction due to damage or when a junction is not properly formed.

It is known to repair pipes from inside and/or outside of the pipe with patches or by removing and replacing a damaged or leaking portion. In addition, pipes used historically and those currently available in new construction are known to be a wide variety of different sizes. Thus, equipment to patch or repair the pipes must be sized accordingly to be used in any repairs that are undertaken, leading to a proliferation of equipment that a repair person must bring to a worksite. Many known solutions for repairing pipes are also not designed to properly repair junctions of lateral pipes and main pipes. As a result, such repaired junctions may remain a weak point in the pipe system, prone to leaking in the future. Accordingly, there remains a significant need for a pipe repair apparatus and method that may be used to properly repair junctions of lateral pipes and main pipes of varying sizes.

### SUMMARY AND ADVANTAGES OF THE INVENTION

The invention provides for such a pipe repair apparatus including a packer assembly having a main bladder body. The main bladder body has a cylindrical shape that extends radially from and along a first axis and is adapted to be inflated with a pressurized fluid from a first circumference narrower than an inner diameter defined by an inner surface of a main pipe to a second circumference at least equal to the inner diameter of the main pipe. A first roller assembly and a second roller assembly are each coupled to the bladder bodies and include at least one rotator motor for rotating the main bladder body. At least one camera is attached to the packer assembly for capturing imaging to determine a position and alignment of the packer assembly.

The invention also provides for a method of repairing a main pipe and a lateral pipe extending transversely from the main pipe including the step of wrapping at least one of a main liner around a main bladder body of a packer assembly and a lateral liner around a lateral bladder body of a packer assembly. The method proceeds by moving the packer assembly into the main pipe and capturing imaging to determine a position of the packer assembly in the main pipe with at least one camera. Then, locating the packer assembly proximate a damaged section of the main pipe. Next, rotating the main bladder body and the lateral bladder body of the packer assembly with at least one rotator motor. The next step of the method is inflating at least one of a main bladder body and a lateral bladder body of the packer assembly with a pressurized fluid. The method concludes by applying at least one of the main liner to an inner surface of the main pipe in response to the inflation of the main bladder body and the lateral liner to an inside surface of the lateral pipe in response to the inflation of the lateral bladder body.

Thus, several advantages of one or more aspects of the pipe repair apparatus and method of repairing a main pipe and a lateral pipe extending from the main pipe are that the apparatus and method may be used for pipes of varying sizes. The pipe repair apparatus and method also advantageously provide for strong repairs of the junction of the lateral pipe and main pipe, thereby preventing future leaks.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a pipe repair apparatus illustrating a packer assembly constructed in accordance with an embodiment of the invention;

FIG. 2 is a perspective view of the pipe repair apparatus of a pipe repair apparatus illustrating a packer assembly constructed in accordance with an embodiment of the invention;

FIG. 3 is a perspective view of the pipe repair apparatus of FIG. 1 illustrating a main bladder body of the packer assembly inflated to a second circumference;

FIG. 4 is an enlarged partial view of the pipe repair apparatus of FIG. 1 illustrating a first roller assembly with a plurality of first actuator arms in a deployed position;

FIG. 5 is an enlarged partial view of the pipe repair apparatus of FIG. 1 illustrating the first roller assembly with the plurality of first actuator arms in a stowed position;

FIG. 6 is an enlarged partial view of the pipe repair apparatus of FIG. 1 illustrating a first adjustable platform and locker assembly of the first roller assembly;

FIG. 7 is a perspective view of a control unit of the pipe repair apparatus configured to connect to the packer assembly of FIG. 1;

FIG. 8 is a perspective view of the control unit of FIG. 7 illustrating a reel for a control cable;

FIG. 9 is an enlarged partial view of the control unit of FIG. 7 illustrating a first control and a second control;

FIG. 10 is a flow chart illustrating steps of repairing a main pipe and a lateral pipe extending from the main pipe; and

FIGS. 11A and 11B are flow charts illustrating steps of repairing the main pipe and the lateral pipe extending from the main pipe.

### DESCRIPTION OF THE ENABLING EMBODIMENT

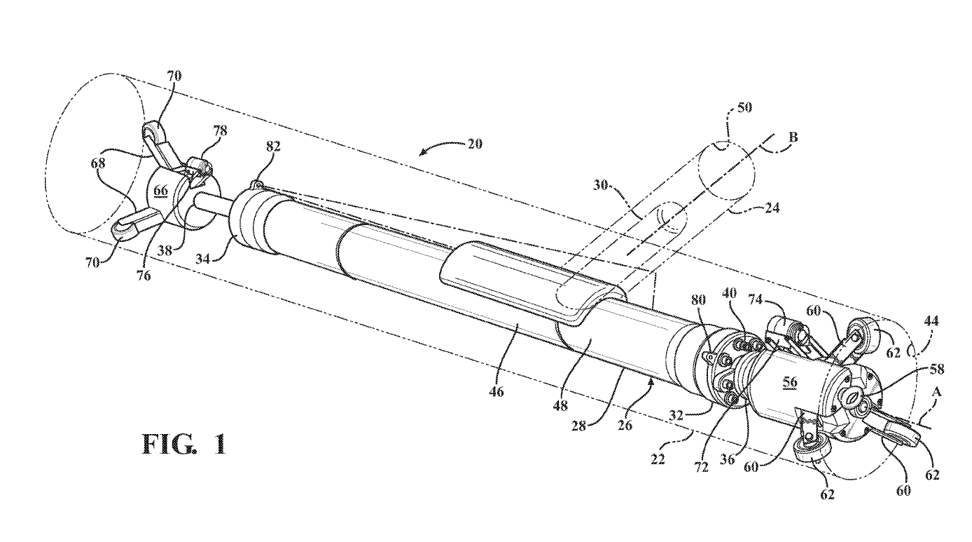

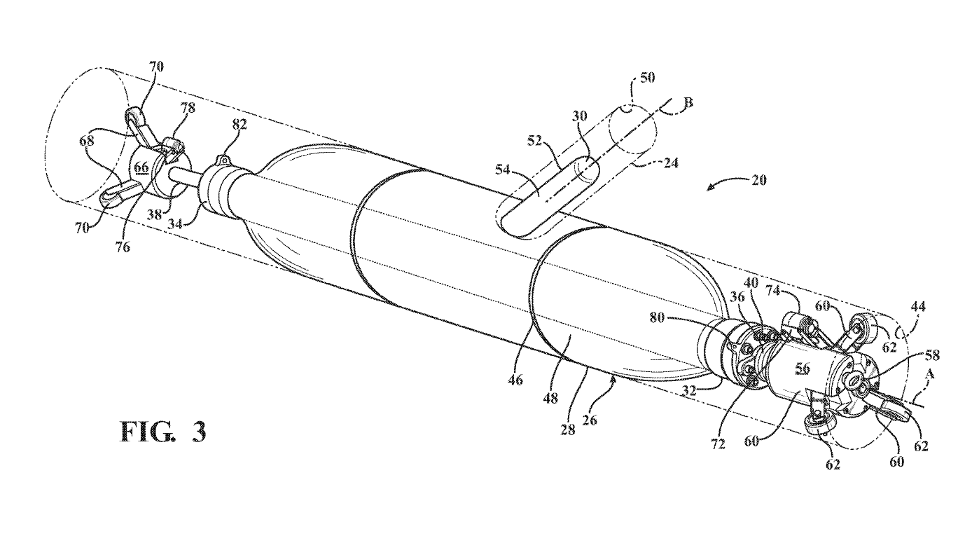

Referring to the Figures, wherein like numerals indicate corresponding parts throughout the several views, a pipe repair apparatus 20 is generally shown in FIGS. 1 and 3 and extends along a first axis A for repairing a main pipe 22 and/or a lateral pipe 24 connected to the main pipe 22 and extending along a second axis B that is transverse to the first axis A. The lateral pipe 24 may extend at any angle laterally from the main pipe 22 including, for example, at a 90 degree angle or at a 45 degree angle. The industry may describe both the foregoing types of repairs of such lateral pipe 24 and main pipe 22 junctions as a “T” repair and a “Y” repair, respectively. The pipe repair apparatus 20 includes a packer assembly 26 having a main bladder body 28 and a lateral bladder body 30. The packer assembly 26 also includes a first end cap 32 and a second end cap 34 disposed at opposite ends of the main bladder body 28 for encapsulating the bladder bodies 28, 30. More specifically, both of such end caps 32, 34 are provided to form the final encapsulation of the bladder bodies 28, 30 along with routing lines for inflation with the pressurized fluid, transportation (i.e., motors 36, 38 and/or cables), and vision, to be described in more detail below.

The packer assembly 26 is intended to be used in connection with inflation equipment, so as a result, both the main bladder body 28 and the lateral bladder body 30 are adapted to receive a pressurized fluid. The pressurized fluid may be a gas, a liquid, or a combination of a gas and a liquid. The first end cap 32 includes a first pressurized fluid port 40 in fluid communication with the main bladder body 28. The first end cap 32 also includes a second pressurized fluid port (not shown) in fluid communication with the lateral bladder body 30. It should be understood that, while the main bladder body 28 and lateral bladder body 30 can receive the pressurized fluid through separate fluid ports, the main bladder body 28 and lateral bladder body 30 could alternatively be connected so that a single pressurized fluid port could provide both bladder bodies 28, 30 with the pressurized fluid.

The main bladder body 28 has a cylindrical shape that extends radially from and along the first axis A and is adapted to be inflated with the pressurized fluid from a first circumference narrower than an inner diameter defined by an inner surface 44 of the main pipe 22 to a second circumference at least equal to the inner diameter of the main pipe 22. A main liner 46 is disposed about the main bladder body 28 for engaging and adhering to the inner surface 44 of the main pipe 22 to repair the main pipe 22 in response to the main bladder body 28 being inflated to the second circumference, as best shown in FIG. 3 (i.e., the main liner 46 is pressed against the portion of the main pipe 22 requiring repair). In detail, the main liner 46 comprises a flat sheet of fiberglass impregnated with a curable resin. A main film 48 of plastic is wrapped around the main bladder body 28 for separating the curable resin of the main liner 46 from the main bladder body 28 (i.e., to prevent the curable resin from adhering to the main bladder body 28). The main film 48 and/or main liner 46 can be secured to the main bladder body 28 with any suitable fastener, such as but not limited to zip ties and/or tape. Once the main liner 46 is left in contact with the inner surface 44 of the main pipe 22, the resin of the main liner 46 can begin to cure.

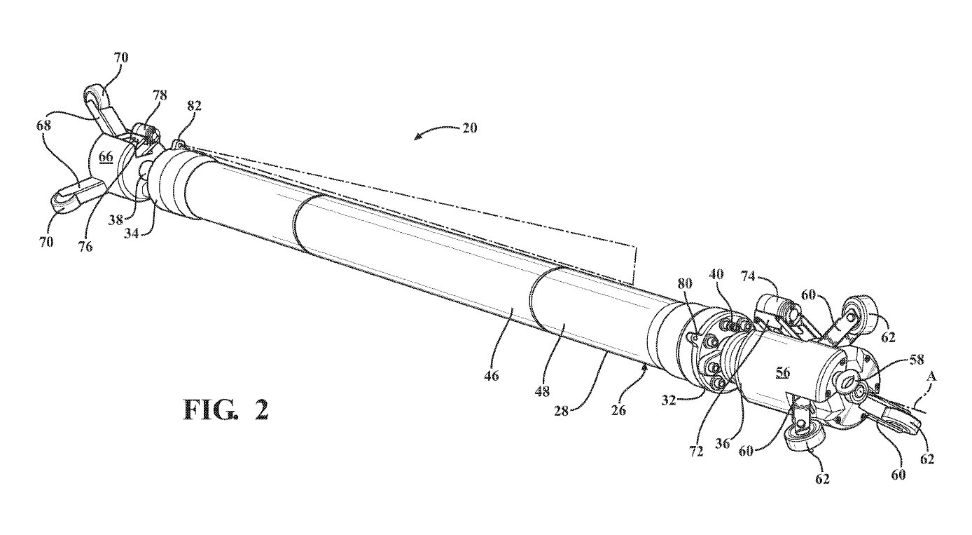

As best shown in FIGS. 1 and 3, the lateral bladder body 30 also has a cylindrical shape that extends radially from and along the second axis B transverse to the first axis A. However, in use, the lateral bladder body 30 may remain folded or rolled up adjacent the main bladder body 28 prior to being inflated. The lateral bladder body 30 attaches to the main bladder body 28 and is adapted to be inflated with pressurized fluid from a first size narrower than an inside diameter defined by an inside surface 50 of a lateral pipe 24 to a second size at least equal to the inside diameter of the lateral pipe 24. The lateral bladder body 30 is adapted to be attached to the main bladder body 28 at a junction including fittings such as male and female fasteners. A lateral liner 52 (FIG. 3) is disposed about the lateral bladder body 30 for engaging and adhering to the inside surface 50 of the lateral pipe 24 to repair the lateral pipe 24 in response to the lateral bladder body 30 being inflated to the second size. As with the main liner 46, the lateral liner 52 comprises a flat sheet of fiberglass impregnated with a curable resin. A lateral film 54 of plastic is wrapped around the lateral bladder body 30 for separating the curable resin of the lateral liner 52 from the lateral bladder body 30. The lateral film 54 and/or lateral liner 52 may be secured to the lateral bladder body 30 using zip ties and/or tape, for example. It is important to provide for a smooth and uniform junction between the main bladder body 28 and the lateral bladder body 30, so that the liners 46, 52 are properly adhered and position against that portion of the repaired pipe during inflation. If such a proper junction is not formed, damage or leaking can occur at the junction between the lateral pipe 24 and the main pipe 22, which is generally known as one of the weakest points in a collection sewer system. While a lateral bladder body 30 may be used, it should be appreciated that the packer assembly 26 may not include a lateral bladder body 30, as best shown in FIG. 2.

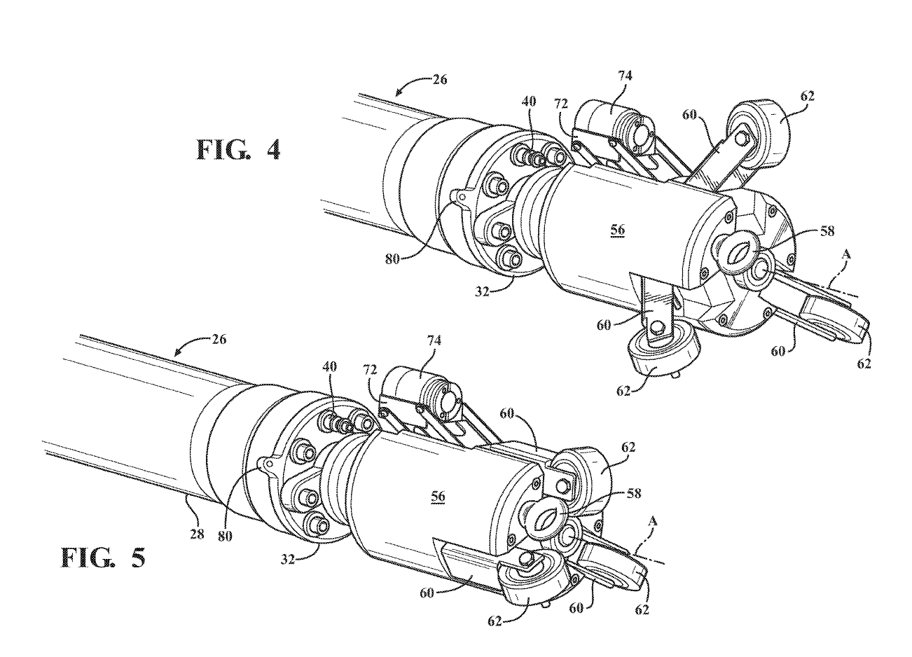

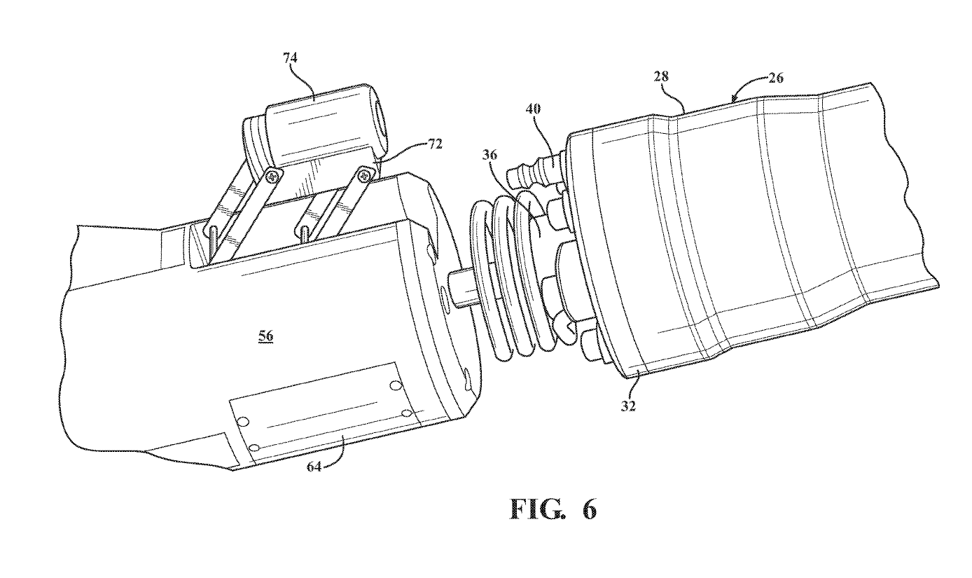

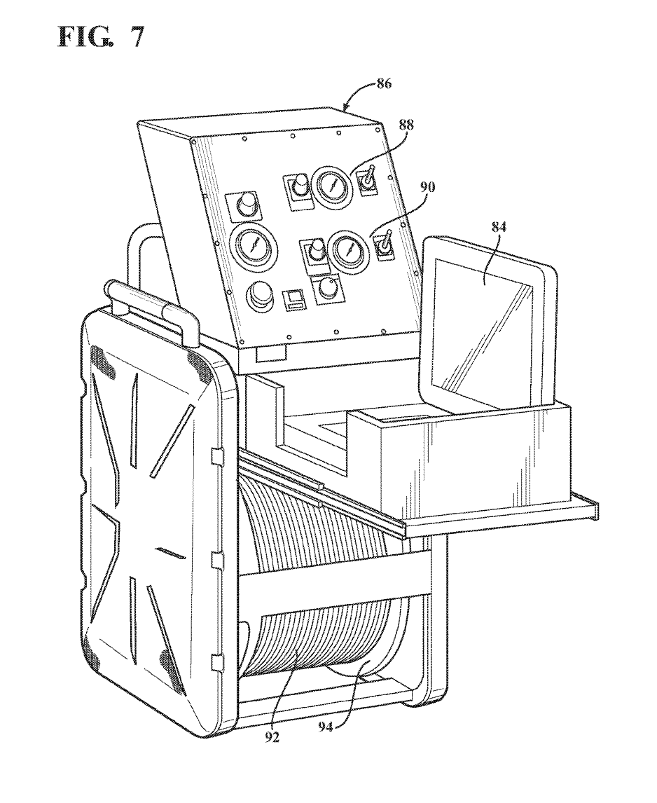

The packer assembly 26 also includes a first roller assembly 56 coupled to the first end cap 32 for supporting and rotating the first end cap 32 and the bladder bodies 28, 30. The first roller assembly 56 includes a cable tie 58 for attachment to a guide cable that may be used in conjunction with a winch, for example, to move the packer assembly 26 through the main pipe 22. The first roller assembly 56 includes a first rotator motor 36 coupled with the first end cap 32 for rotating the first end cap 32 and the bladder bodies 28, 30. Additionally, the first roller assembly 56 includes a plurality of first actuator arms 60 movably coupled to the first roller assembly 56 for moving radially outwardly from the first roller assembly 56 (e.g., outwardly to a deployed position shown in FIG. 4 from a stowed position shown in FIG. 5). A first actuator motor (not shown) is coupled to the first actuator arms 60 for moving the first actuator arms 60 relative to the first roller assembly 56. The first actuator arms 60 each include a first roller wheel 62 rotatably attached to the first actuator arm 60 to engage the inner surface 44 of the main pipe 22. The first roller assembly 56 also includes a locker assembly 64 (FIG. 6) coupled to the first roller assembly 56 for locking the packer assembly 26 in position relative to the main pipe 22.

Referring back to FIGS. 1 and 3, the packer assembly 26 includes a second roller assembly 66 coupled to the second end cap 34 for supporting and rotating the packer assembly 26. As with the first roller assembly 56, the second roller assembly 66 includes a plurality of second actuator arms 68 movably coupled to the second roller assembly 66 for moving radially outwardly from the second roller assembly 66. The second actuator arms 68 each include a second roller wheel 70 rotatably attached to the second actuator arm 68 to engage the inner surface 44 of the main pipe 22. The second roller assembly 66 also includes a second rotator motor 38 coupled with the second end cap 34 for rotating the second end cap 34 and the bladder bodies 28, 30. It should be appreciated that while both the first and second rotator motors 36, 38 may be used, the packer assembly 26 may instead only include one rotator motor. A second actuator motor (not shown) is coupled to the second actuator arms 68 for moving the second actuator arms 68 relative to the second roller assembly 66. It should be understood that while the actuator arms 60, 68 may be moved by the first and/or second actuator motors 36, 38, the actuator arms 60, 68 could alternatively be moved by a fluid or pneumatic force. In any event, the first and second actuator arms 60, 68 enable the pipe repair apparatus 20 to easily adapt to pipes of various sizes.

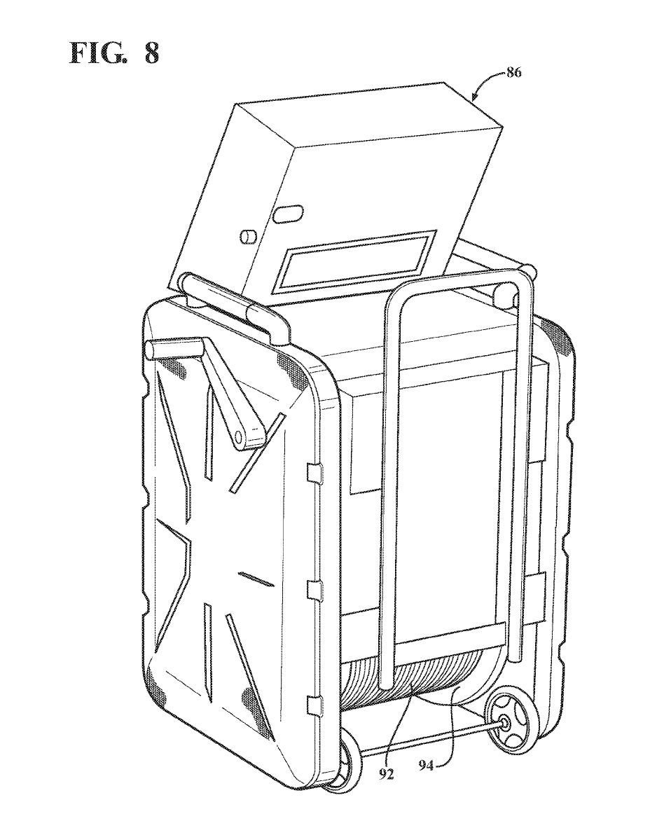

The first roller assembly 56 includes a first adjustable platform 72 (FIG. 6) coupled to the first roller assembly 56. A first camera 74 is attached to the first adjustable platform 72 for capturing imaging to determine a position and alignment of the pipe repair apparatus 20. The second roller assembly 66 similarly includes a second adjustable platform 76 (FIGS. 1 and 3) coupled to the second roller assembly 66 and a second camera 78 is attached to the second adjustable platform 76 for capturing imaging to determine a position and alignment of the pipe repair apparatus 20. The first end cap 32 includes a first laser 80 attached to the first end cap 32 for projecting a beam axially toward the second camera 78. The second end cap 34 includes a second laser 82 attached to the second end cap 34 for projecting a beam axially toward the first camera 74. A handheld device 84 (FIG. 7) is in communication with the first camera 74 and the second camera 78 for receiving imaging from the first camera 74 and the second camera 78 to confirm positioning and alignment of the packer assembly 26.

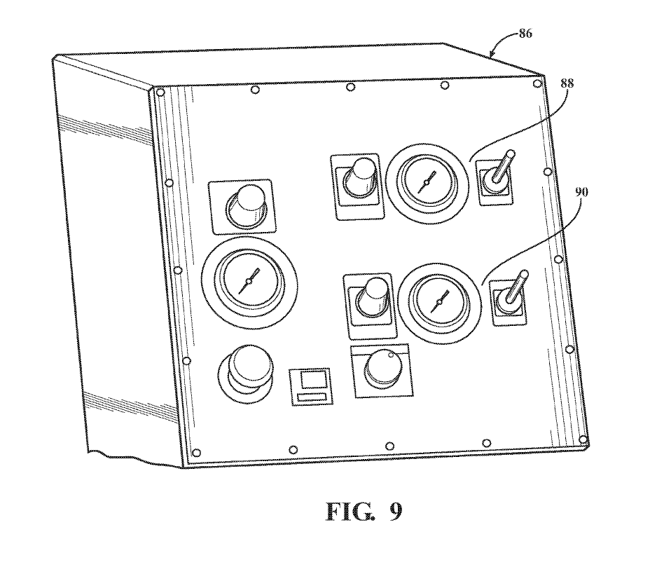

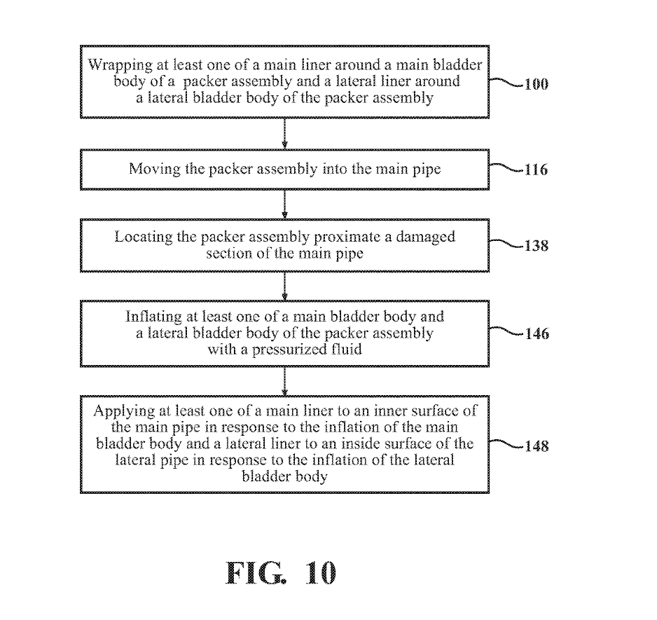

As best shown in FIGS. 7-9, a control unit 86 has a first control 88 and a second control 90 for coupling to and controlling the packer assembly 26. While the control unit 86 can be used along with separate inflation equipment, the control unit 86 may instead carry out the functions of any separate inflation equipment (e.g., supplying the pressurized fluid). A control line 92 is adapted to couple with the packer assembly 26 with the control unit 86 for providing power and control signals to the packer assembly 26 (e.g., power to the actuator motors 36, 38). The control unit 86 may also include a reel 94 (FIGS. 7 and 8) to manage the control line 92. A first pressurized fluid line (not shown) couples the control unit 86 with the packer assembly 26 through the first pressurized fluid port 40 for providing a pressurized fluid to the main bladder body 28 in response to operation of the first control 88. Likewise, a second pressurized fluid line (not shown) couples the control unit 86 with the packer assembly 26 through the second pressurized fluid port 42 for providing a pressurized fluid to the lateral bladder body 30 in response to operation of the second control 90. Use of the separate first and second pressurized fluid lines and control unit 86 permits the operator to properly inflate each of the main bladder body 28 and lateral bladder body 30 in order to cause a better seal at the junction.

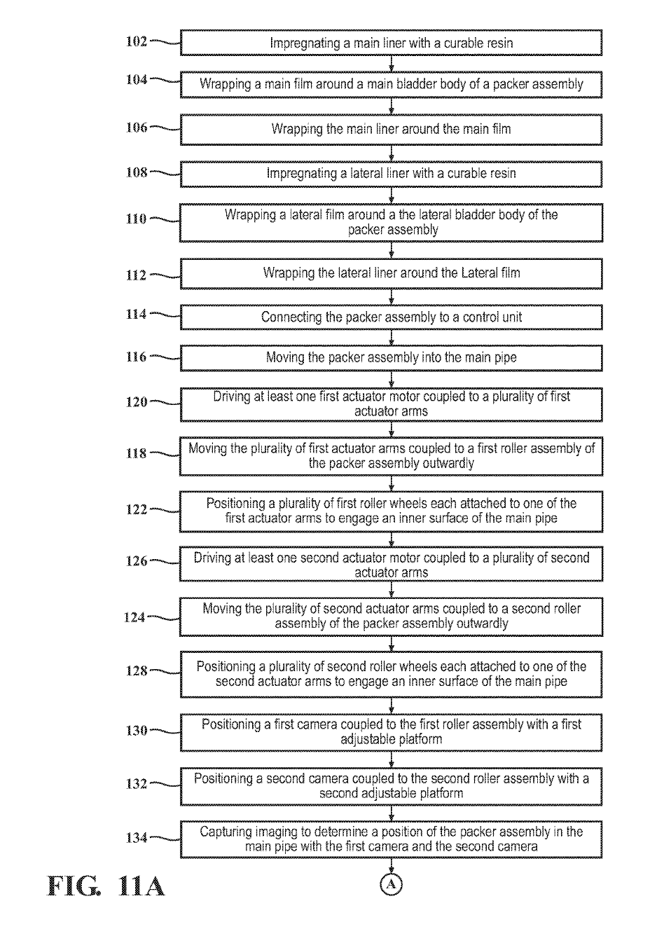

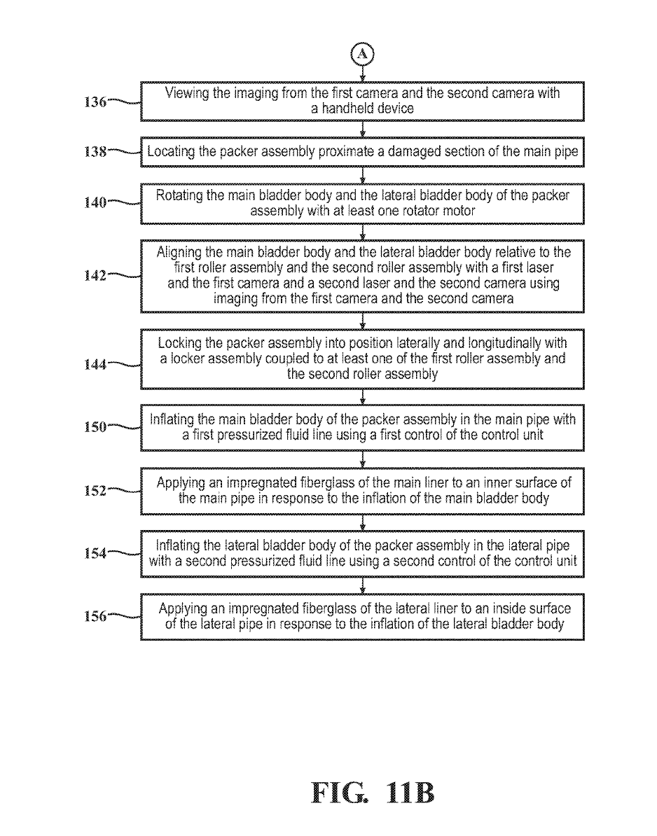

As shown in FIGS. 10, 11A and 11B, a method of repairing a main pipe 22 and a lateral pipe 24 extending from the main pipe 22 is also disclosed. The method begins with the step of 100 wrapping at least one of a main liner 46 around a main bladder body 28 of a packer assembly 26 and a lateral liner 52 around a lateral bladder body 30 of the packer assembly 26. Specifically, such a step may include 102 impregnating a main liner 46 with a curable resin and 104 wrapping a main film 48 around the main bladder body 28 of a packer assembly 26. Next, 106 wrapping the main liner 46 around the main film 48. The method proceeds by 108 impregnating the lateral liner 52 with a curable resin and 110 wrapping a lateral film 54 around the lateral bladder body 30 of the packer assembly 22. Then, 112 wrapping the lateral liner 52 around the lateral film 54.

The next steps of the method are 114 connecting the packer assembly 26 to a control unit 86 and 116 moving the packer assembly 26 into the main pipe 22. For example, the packer assembly 26 can be pulled with use of cables attached to the cable tie 58 to the damaged location. Then, 118 moving a plurality of first actuator arms 60 coupled to a first roller assembly 56 of the packer assembly 26 outwardly (FIG. 4). This can be accomplished by 120 driving at least one first actuator motor coupled to the first actuator arms 60 (i.e., the actuator arms 60, 68 move in response to driving the at least one first actuator motor). As described above, the actuator arms 60, 68 could instead be moved using a fluid or pneumatic pressure instead. The method continues with 122 positioning a plurality of first roller wheels 62 each attached to one of the first actuator arms 60 to engage an inner surface 44 of the main pipe 22. As with the first actuator arms 60, the method includes the step of 124 moving a plurality of second actuator arms 68 coupled to a second roller assembly 66 of the packer assembly 26 outwardly. Such movement can be carried out by 126 driving at least one second actuator motor coupled to the second actuator arms 68. The method also includes the step of 128 positioning a plurality of second roller wheels 70 attached to each of the second actuator arms 68 to engage the inner surface 44 of the main pipe 22.

The method continues by 130 positioning a first camera 74 coupled to the first roller assembly 56 with a first adjustable platform 72 and 132 positioning a second camera 78 coupled to the second roller assembly 66 with a second adjustable platform 76. Next, 134 capturing imaging to determine a position of the packer assembly 26 in the main pipe 22 with the first camera 74 and the second camera 78. The method proceeds by 136 viewing the imaging from the first camera 74 and the second camera 78 with a handheld device 84 and 138 locating the packer assembly 26 proximate a damaged section of the main pipe 22.

Although the packer assembly 26 may be pulled to the longitudinal position of the damaged pipe, the repair required may be at some point inside the main pipe 22 which requires the packer assembly 26 to be rotated about the first axis A. So the method includes the step of 140 rotating the main bladder body 28 and the lateral bladder body 30 of the packer assembly 26 with at least one rotator motor. Next, 142 aligning the main bladder body 28 and the lateral bladder body 30 relative to the first roller assembly 56 and the second roller assembly 66 with a first laser 80 and the first camera 74 and a second laser 82 and the second camera 78 using imaging from the first camera 74 and the second camera 78. In detail, the operator uses the cameras 74, 78 to position the packer assembly 26 and the lasers 80, 82 to ensure each of the first and second end caps 32, 34 are in the appropriate position, typically aligned. Having the rotational adjustment is particularly important for locating and positioning the lateral bladder body 30 at the opening of a lateral pipe 24 (i.e., “T” or “Y” location). The method continues with 144 locking the packer assembly 26 into position laterally and longitudinally with a locker assembly 64 coupled to at least one of the first roller assembly 56 and the second roller assembly 66.

The method includes 146 inflating at least one of a main bladder body 28 and a lateral bladder body 30 of the packer assembly 26 with a pressurized fluid and 148 applying at least one of a main liner 46 to an inner surface 44 of the main pipe 22 in response to the inflation of the main bladder body 28 and a lateral liner 52 to an inside surface 50 of the lateral pipe 24 in response to the inflation of the lateral bladder body 30. More specifically, such a steps 146, 148 can include inflating the main bladder body 28 of the packer assembly 26 in the main pipe 22 with a first pressurized fluid line using a first control 88 of the control unit 86 (FIG. 3). Then, 152 applying an impregnated fiberglass of the main liner 46 to an inner surface 44 of the main pipe 22 in response to the inflation of the main bladder body 28. The impregnated fiberglass can then cure against the damaged location of the main pipe 22 to form a properly sealed and repaired main pipe 22.

The steps 146, 148 likewise can include the step of 154 inflating the lateral bladder body 30 of the packer assembly 26 in the lateral pipe 24 extending from the main pipe 22 with a second pressurized fluid line using a second control 90 of the control unit 86 to a second diameter. Next, 156 applying an impregnated fiberglass of the lateral liner 52 to an inside surface 50 of the lateral pipe 24 in response to the inflation of the lateral bladder body 30. The impregnated fiberglass of the lateral liner 52 cures against the damaged location of the lateral pipe 24 to form a properly sealed and repaired lateral pipe 24. It should be appreciated that while the method described above includes applying both a main liner 46 and a lateral liner 52, the pipe repair apparatus 20 could be used to apply a main liner 46 only, or a lateral liner 52 only.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

1. A pipe repair apparatus comprising:
a packer assembly having a main bladder body;
said main bladder body having a cylindrical shape extending radially from and along a first axis and adapted to be inflated with a pressurized fluid from a first circumference narrower than an inner diameter defined by an inner surface of a main pipe to a second circumference at least equal to the inner diameter of the main pipe;
a first roller assembly and a second roller assembly each coupled to said main bladder body and including at least one rotator motor for rotating said main bladder body; and
at least one camera attached to said packer assembly for capturing imaging to determine a position and alignment of said packer assembly.

2. A pipe repair apparatus as set forth in claim 1, wherein:
said first roller assembly includes a plurality of first actuator arms movably coupled to said first roller assembly for moving radially outwardly from said first roller assembly;
said first actuator arms each include a first roller wheel rotatably attached to said first actuator arms to engage the inner surface of the main pipe;
said second roller assembly includes a plurality of second actuator arms movably coupled to said second roller assembly for moving radially outwardly from said second roller assembly; and
said second actuator arms each include a second roller wheel rotatably attached to said second actuator arms to engage the inner surface of the main pipe.

3. A pipe repair apparatus as set forth in claim 1, further including a main liner disposed about said main bladder body for engaging and adhering to the inner surface of the main pipe to repair the main pipe in response to said main bladder body being inflated to the second circumference.

4. A pipe repair apparatus as set forth in claim 3, wherein said main liner comprises a flat sheet of fiberglass impregnated with a curable resin.

5. A pipe repair apparatus as set forth in claim 4, further including a main film of plastic wrapped around said main bladder body for separating said curable resin adjacent to said sheet of fiberglass from said main bladder.

6. A pipe repair apparatus as set forth in claim 1, wherein said at least one camera includes a first camera attached to said first roller assembly and a second camera attached to said second roller assembly.

7. A pipe repair apparatus as set forth in claim 6, further including a first laser attached to said packer assembly for projecting a beam axially toward said second camera and a second laser attached to said packer assembly for projecting a beam axially toward said first camera.

8. A pipe repair apparatus as set forth in claim 1, wherein said packer assembly includes a lateral bladder body having a cylindrical shape extending radially from and along a second axis transverse to said first axis and attached to said main bladder body and adapted to be inflated with the pressurized fluid from a first size narrower than an inside diameter defined by an inside surface of a lateral pipe to a second size at least equal to the inside diameter of the lateral pipe and said pipe repair apparatus further including a lateral liner disposed about said lateral bladder body for engaging and adhering to the inside surface of the lateral pipe to repair the lateral pipe in response to said lateral bladder body being inflated to the second size.

9. A pipe repair apparatus as set forth in claim 8, further including a control unit having a first control for inflating and deflating said main bladder body and having a second control for inflating and deflating said lateral bladder body.

10. A method of repairing a main pipe and a lateral pipe extending transversely from the main pipe comprising the steps of:
wrapping at least one of a main liner around a main bladder body of a packer assembly and a lateral liner around a lateral bladder body of the packer assembly;
moving the packer assembly into the main pipe;
capturing imaging to determine a position of the packer assembly in the main pipe with at least one camera;
locating the packer assembly proximate a damaged section of the main pipe;
rotating the main bladder body and the lateral bladder body of the packer assembly with at least one rotator motor;
inflating at least one of the main bladder body and the lateral bladder body of the packer assembly with a pressurized fluid; and
applying at least one of the main liner to an inner surface of the main pipe in response to the inflation of the main bladder body and the lateral liner to an inside surface of the lateral pipe in response to the inflation of the lateral bladder body.

11. A method as set forth in claim 10, further including the steps of:
moving a plurality of first actuator arms coupled to a first roller assembly of the packer assembly outwardly;
positioning a plurality of first roller wheels attached to each of the first actuator arms to engage an inner surface of the main pipe;
moving a plurality of second actuator arms coupled to a second roller assembly of the packer assembly outwardly; and
positioning a plurality of second roller wheels attached to each of the second actuator arms to engage the inner surface of the main pipe.

12. A method as set forth in claim 11, wherein the step of moving a plurality of first actuator arms coupled to a first roller assembly of the packer assembly outwardly includes driving at least one first actuator motor coupled to the first actuator arms and wherein the step of moving a plurality of second actuator arms coupled to a second roller assembly of the packer assembly outwardly includes driving at least one second actuator motor coupled to the second actuator arms.

13. A method as set forth in claim 10, further including the step of aligning the main bladder body and the lateral bladder body relative to the first roller assembly and the second roller assembly with a first laser and the first camera and a second laser and the second camera using imaging from the first camera and the second camera.

14. A method as set forth in claim 10, further including the step of locking the packer assembly into position laterally and longitudinally with a locker assembly.

15. A method as set forth in claim 10, further including the steps of:
impregnating the main liner with a curable resin;
wrapping a main film around the main bladder body;
wrapping the main liner around the main film;
impregnating the lateral liner with a curable resin;
wrapping a lateral film around the lateral bladder body; and
wrapping the lateral liner around the lateral film.

16. A pipe repair apparatus as set forth in claim 1, wherein said packer assembly includes a first end cap and a second end cap disposed at opposite ends of said main bladder body for encapsulating said main bladder body and said at least one rotator motor includes a first rotator motor disposed in said first roller assembly and coupled to said first end cap and a second rotator motor disposed in said second roller assembly and coupled to said second end cap for rotating said end caps and said main bladder body.

17. A pipe repair apparatus as set forth in claim 1, wherein said first roller assembly includes a first adjustable platform and said second roller assembly includes a second adjustable platform and said at least one camera includes a first camera attached to said first adjustable platform and a second camera attached to said second adjustable platform.

18. A pipe repair apparatus as set forth in claim 1, wherein said first roller assembly includes a locker assembly for locking said packer assembly in position relative to the main pipe.

19. A pipe repair apparatus as set forth in claim 1, further including a handheld device in communication with said at least one camera for receiving imaging from said at least one camera to confirm positioning and alignment of said packer assembly.

20. A pipe repair apparatus as set forth in claim 8, wherein said lateral body remains rolled up adjacent said main bladder body prior to being inflated.
